(19) United States
(12) Patent Application Publication
(10) Pub. No.: US 2025/0050449 A1
(43) Pub. Date: Feb. 13, 2025

(54) LASER-FRAGMENTATION-IN-LIQUID DEVICE AND LASER-FRAGMENTATION-IN-LIQUID APPARATUS

(71) Applicant: NEW-TECH CORPORATION, Kyoto (JP)

(72) Inventors: Kazuyuki HIRAO, Kyoto (JP); Qiang GONG, Kyoto (JP); Kohji NAGASHIMA, Kyoto (JP); Takeshi FUJIWARA, Kyoto (JP); Kazunori YAMASHITA, Kyoto (JP)

(21) Appl. No.: 18/669,465

(22) Filed: May 20, 2024

(30) Foreign Application Priority Data
Aug. 10, 2023 (JP) 2023-131264

(51) Int. Cl. B23K 26/146

(52) U.S. Cl. CPC B23K 26/146

(57) ABSTRACT

An LFL device includes a device body and an ultrasound applier. The ultrasound applier is mounted on the device body. The device body includes an internal flow path that allows passage of metal particle dispersion in which metal microparticles are dispersed. The ultrasound applier applies ultrasound to the metal particle dispersion that is flowing through the internal flow path. An outer surface of the device body is provided with a light transmitting part that transmits a laser beam. The laser beam is irradiated to the metal particle dispersion in the internal flow path to which ultrasound has been applied by the ultrasound applier. This improves uniformity of irradiation of metal microparticles with laser beams.

### CROSS-REFERENCE TO RELATED APPLICATION

This application claims priority benefit of Japanese Patent Application No. 2023-131264 filed in the Japan Patent Office on Aug. 10, 2023, the entire disclosure of which is incorporated herein by reference.

### TECHNICAL FIELD

The present invention relates to a device and apparatus for use in laser fragmentation of metal particles in a liquid.

### BACKGROUND ART

In recent years, laser ablation in liquid in which laser ablation is performed by laser irradiating a target in a liquid is used as a method of generating metal microparticles, which are microparticles of metal or a metallic compound. For example, Japanese Patent Application Laid-Open No. 2011-161379 (Document 1) proposes a laser-ablation-in-liquid (LAL) apparatus that contains a metallic material arranged at the bottom of a flask for storing a solvent such as ethanol and irradiates the metallic material with laser transmitted through the bottom of the flask so as to generate metal microparticles. Japanese Patent Application Laid-Open No. 2020-176288 (Document 2) proposes a technique for fragmenting metal microparticles in a liquid stored in an acrylic container by irradiation with pulse laser.

In the apparatus disclosed in Document 2, since the pulse laser is applied to the metal microparticles floating in a liquid stored in the acrylic container, the irradiation of the metal microparticles with laser may become non-uniform due to, for example, a low density of metal microparticles in the liquid. As a result, the particle diameters of the fragmented metal microparticles after the laser irradiation may become non-uniform.

### SUMMARY OF THE INVENTION

The present invention is intended for a device and apparatus for use in laser fragmentation of metal particles in a liquid, and it is an object of the present invention to improve uniformity of irradiation of metal microparticles with laser beams.

A first aspect of the present invention is a laser-fragmentation-in-liquid device that includes a device body and an ultrasound applier mounted on the device body. The device body includes an internal flow path that allows passage of metal particle dispersion in which metal microparticles are dispersed. The ultrasound applier applies ultrasound to the metal particle dispersion that is flowing through the internal flow path. An outer surface of the device body is provided with a light transmitting part that transmits a laser beam, the laser beam being irradiated to the metal particle dispersion in the internal flow path to which ultrasound has been applied by the ultrasound applier.

According to the present invention, it is possible to improve uniformity of irradiation of the metal microparticles with laser beams.

A second aspect of the present invention is the laser-fragmentation-in-liquid device according to the first aspect, in which the device body includes a supply port that is located at an upstream end of the internal flow path and to which the metal particle dispersion is supplied and a drain port that is located at a downstream end of the internal flow path and from which the metal particle dispersion irradiated with the laser beam transmitted through the light transmitting part is drained. The internal flow path includes a light receiver that is irradiated with the laser beam transmitted through the light transmitting part. The application of ultrasound to the metal particle dispersion by the ultrasound applier is conducted between the supply port and the light receiver of the internal flow path.

A third aspect of the present invention is the laser-fragmentation-in-liquid device according to the first aspect (or the first or second aspect), in which the internal flow path includes a light receiver that is irradiated with the laser beam transmitted through the light transmitting part. The light receiver extends in an up-down direction. The metal particle dispersion flows from a lower side to an upper side in the light receiver.

A fourth aspect of the present invention is the laser-fragmentation-in-liquid device according to the first aspect (or any one of the first to third aspects), in which the internal flow path includes a light receiver that is irradiated with the laser beam transmitted through the light transmitting part. A direction of incidence of the laser beam on the light receiver is parallel to a thickness direction of the device body. The device body has a thickness smaller than dimensions of the device body in longitudinal and lateral directions perpendicular to the thickness direction.

A fifth aspect of the present invention is the laser-fragmentation-in-liquid device according to the first aspect (or any one of the first to fourth aspects), in which the internal flow path includes a light receiver that is irradiated with the laser beam transmitted through the light transmitting part. A direction of incidence of the laser beam on the light receiver is parallel to a thickness direction of the device body. The laser-fragmentation-in-liquid device further includes a flow-path-thickness changer that changes a thickness of the light receiver in the thickness direction.

A sixth aspect of the present invention is the laser-fragmentation-in-liquid device according to the fifth aspect that further includes a light-transmission-rate measurement device that measures a light transmission rate of the metal particle dispersion in the light receiver. A controller that drives the flow-path-thickness changer in accordance with an output of the light-transmission-rate measurement device.

A seventh aspect of the present invention is a laser-fragmentation-in-liquid apparatus that includes the laser-fragmentation-in-liquid device according to the first aspect (or any one of the first to sixth aspects), a dispersion supplier that supplies the metal particle dispersion to the internal flow path of the laser-fragmentation-in-liquid device, a light source that emits a laser beam toward the light transmitting part of the laser-fragmentation-in-liquid device, and a dispersion collector that collects the metal particle dispersion drained from the internal flow path of the laser-fragmentation-in-liquid device.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view of a laser-fragmentation-in-liquid (LFL) apparatus according to Embodiment 1.

FIG. 2 is a side view of the LFL apparatus.

FIG. 3 is a longitudinal sectional view of an LFL device according to Embodiment 2.

FIG. 4 is a diagram showing a configuration of a computer.

### DETAILED DESCRIPTION

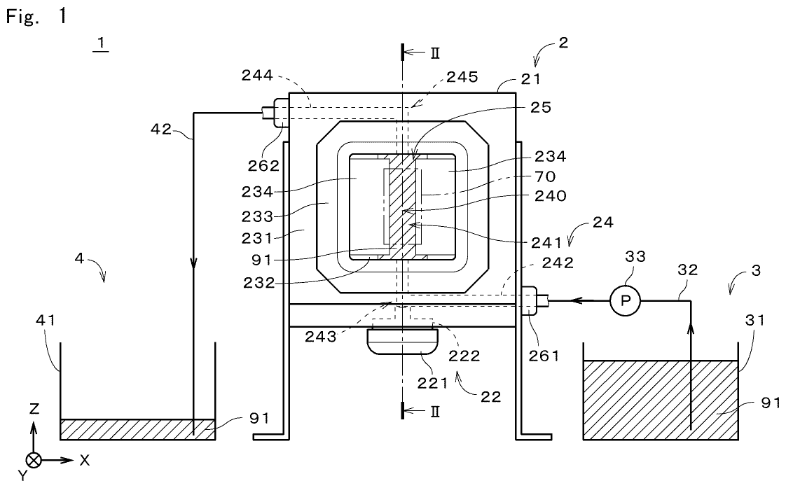

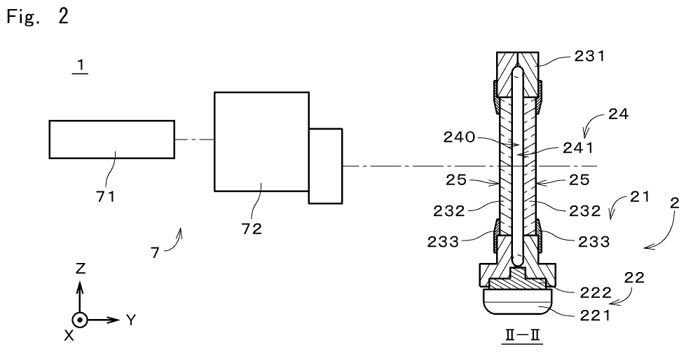

FIG. 1 is a front view showing a configuration of a laser-fragmentation-in-liquid apparatus 1 according to Embodiment 1 of the present invention. FIG. 2 is a side view showing the configuration of the laser-fragmentation-in-liquid apparatus 1. In FIGS. 1 and 2, three directions orthogonal to one another are indicated as X, Y, and Z directions by arrows. In the example shown in FIGS. 1 and 2, the X and Y directions are horizontal directions orthogonal to each other, and the Z direction is a vertical direction. For convenience of illustration, part of the configuration of the laser-fragmentation-in-liquid apparatus 1 is not shown in FIGS. 1 and 2. In FIG. 2, part of the configuration of the laser-fragmentation-in-liquid apparatus 1 is shown in cross-section perpendicular to the X direction.

The laser-fragmentation-in-liquid apparatus 1 is an apparatus for performing laser fragmentation in liquid (LFL) in which metal microparticles dispersed in a liquid are fragmented by irradiation with laser beams. In the following description, the laser-fragmentation-in-liquid apparatus 1 is also referred to as the “LFL apparatus 1.” The aforementioned metal microparticles may be any of microparticles of simple metal, microparticles of a metallic compound (e.g., metallic oxide), and microparticles of an alloy. Alternatively, the metal microparticles may also be a mixture of any two or more of microparticles of simple metal, microparticles of a metallic compound, and microparticles of an alloy.

The LFL apparatus 1 includes a laser-fragmentation-in-liquid device 2 (hereinafter, also referred to as the “LFL device 2”), a dispersion supplier 3, a dispersion collector 4, and a light source part 7. The dispersion supplier 3 contains metal particle dispersion 91 and supplies the metal particle dispersion 91 to the LFL device 2. The metal particle dispersion 91 is obtained by dispersing the aforementioned metal microparticles into a liquid solvent. In FIG. 1, the metal particle dispersion 91 are cross-hatched in order to facilitate understanding of the drawing.

The solvent in the metal particle dispersion 91 may, for example, be glycerin, ethanol, or isopropanol. The metal microparticles may be obtained by, for example, coating the surfaces of particles of simple metal such as silver (Ag) with a protectant. The protectant may, for example, be an organic high-polymer compound such as polyvinyl pyrrolidone (PVP), polyethylene glycol (PEG), or polyvinyl alcohol (PVA).

The metal microparticles in the metal particle dispersion 91 contained in the dispersion supplier 3 may have an average particle diameter of, for example, less than or equal to 200 nm and preferably less than or equal to 100 nm. There are no particular limitations on the lower limit for the average particle diameter, but for example, the lower limit may be greater than or equal to 50 nm. The average particle diameter is obtained as an arithmetical mean of the particle diameters of 150 or more metal microparticles among 300 or more metal microparticles observed within a field of view with an electron microscope. Note that the type and average particle diameter of the metal microparticles and the type of the protectant may be modified in various ways. Alternatively, the protectant may be omitted.

The dispersion supplier 3 includes a supply container 31, a supply line 32, and a solution sender 33. The supply container 31 stores the metal particle dispersion 91 before being supplied to the LFL device 2. For example, the supply container 31 may be a graduated measuring cylinder, a flask, a test glass, or a beaker. The supply line 32 connects the supply container 31 and the LFL device 2. The supply line 32 may, for example, be a flexible pipe made of resin. For example, the supply line 32 may be a transparent line. The solution sender 33 is provided between the supply container 31 and the LFL device 2 in the supply line 32. The solution sender 33 sends the metal particle dispersion 91 stored in the supply container 31 to the LFL device 2 through the supply line 32. For example, the solution sender 33 may be an axial-flow or centrifugal pump. Note that the shapes, materials, and structures of the supply container 31, the supply line 32, and the solution sender 33 may be modified in various ways. The structure of the dispersion supplier 3 may also be modified in various ways.

The LFL device 2 is a member (so-called reactor) that transmits therethrough the metal particle dispersion 91 supplied from the dispersion supplier 3. The LFL device 2 is configured to be capable of irradiating the metal particle dispersion 91 flowing therethrough with a laser beam emitted from the light source part 7. In the example shown in FIGS. 1 and 2, the LFL device 2 is an approximately flat plate-like or rectangular parallelepiped member that is thin in the Y direction. For example, the LFL device 2 may have an approximately rectangular shape when viewed from the front (i.e., the shape viewed in the Y direction). A detailed structure of the LFL device 2 will be described later.

In the LFL apparatus 1, the metal particle dispersion 91 flowing through the LFL device 2 is irradiated with the laser beam emitted from the light source part 7. The light source part 7 includes a laser light source 71 and a galvano scanner 72. For example, the laser light source 71 may be a laser transmitter that emits a pulse laser beam with a pulse width of 80 femtoseconds to 2 microseconds and a wavelength of 19 nm to 10.6 μm. The energy per pulse of the pulse laser beam may be in the range of, for example, 50 μJ to 5 J. Note that the type and aforementioned properties of the laser beam emitted from the laser light source 71 may be modified in various ways.

The laser beam emitted from the laser light source 71 is guided to the galvano scanner 72. The galvano scanner 72 includes a galvano mirror and a galvano motor and reflects and guides the laser beam emitted from the laser light source 71 to the LFL device 2. The laser beam reflected by the galvano scanner 72 is guided in approximately parallel with the Y direction and enters the LFL device 2. The position to be irradiated with the laser beam on the LFL device 2 is scanned by the galvano scanner 72. Accordingly, a predetermined region (hereinafter, also referred to as a “scanned region 70”) on the LFL device 2 is irradiated with the laser beam. In FIG. 1, the scanned region 70 is indicated by being enclosed by a chain double-dashed line. In the example shown in FIG. 1, the scanned region 70 is located in approximately the center of the LFL device 2 and has an approximately rectangular shape. Note that the shape of the scanned region 70 may be modified in various ways. The structure of the light source part 7 may also be modified in various ways. For example, instead of the galvano scanner 72, another constituent element for scanning the laser beam may be provided.

In the LFL device 2, the aforementioned scanned region 70 includes part of an internal flow path 24 (described later) through which the metal particle dispersion 91 flows, and the laser beam emitted from the light source part 7 is applied to the metal particle dispersion 91 flowing through the internal flow path 24. This causes fragmentation of metal microparticles dispersed in the metal particle dispersion 91. The metal particle dispersion 91 containing the fragmented metal microparticles is drained from the LFL device 2 and collected by the dispersion collector 4. The dispersion collector 4 includes a collection container 41 and a collection line 42. The collection container 41 collects and stores the metal particle dispersion 91 drained from the LFL device 2 through the collection line 42. The collection container 41 may, for example, be a graduated measuring cylinder, a flask, a test glass, or a beaker. The collection line 42 connects the collection container 41 and the LFL device 2. The collection line 42 may, for example, be a flexible pipe made of resin. For example, the collection line 42 may be a transparent line. Note that the shapes, materials, and structures of the collection container 41 and the collection line 42 may be modified in various ways. The structure of the dispersion collector 4 may also be modified in various ways. For example, the aforementioned solution sender 33 may be provided not in the dispersion supplier 3, but in the collection line 42 of the dispersion collector 4.

The LFL device 2 includes a device body 21 and an ultrasound applier 22. The device body 21 is an approximately flat plate-like or rectangular parallelepiped member that is thin in the Y direction. In other words, the thickness of the device body 21 in the Y direction (i.e., thickness direction) is smaller than the dimensions of the device body 21 in the Z and X directions (i.e., longitudinal and lateral directions). The thickness of the device body 21 in the Y direction may be in the range of, for example, 0.1 mm to 10 mm. The width of the device body 21 in the X direction may be in the range of, for example, 1 mm to 300 mm. The height of the device body 21 in the Z direction may be in the range of, for example, 1 mm to 300 mm. The dimensions and shape of the device body 21 may be modified in various ways.

The device body 21 includes a frame 231 and two light transmitting members 232. The frame 231 is an approximately rectangular frame-like member provided with an approximately rectangular opening in the center when viewed from the front. Each of the two light transmitting members 232 is a member having light transmission properties and having an approximately rectangular shape when viewed from the front. For example, the light transmitting members 232 may be approximately flat plate-like transparent members and expand approximately perpendicularly to the Y direction. The two light transmitting members 232 are mounted on the frame 231 by being fitted in the aforementioned opening of the frame 231. The two light transmitting members 232 are arranged spaced from each other and facing each other in the Y direction.

Each light transmitting member 232 is connected to the frame 231 by a connecting member 233 having an approximately rectangular frame-like shape when viewed from the front. The connecting member 233 is an approximately flat plate-like member that covers approximately the entire outer peripheral edge portion of the light transmitting member 232 when viewed from the front. For example, the frame 231 and the connecting members 233 may be made of resin. Each light transmitting member 232 may be made of, for example, vitreous silica. Note that the materials and shapes of the frame 231, the light transmitting members 232, and the connecting members 233 may be modified in various ways. Alternatively, the light transmitting members 232 may be semi-transparent members.

In the example shown in FIGS. 1 and 2, the connecting members 233 have no light transmission properties (i.e., non-transparent members). In the LFL device 2, portions of the light transmitting members 232 that are exposed from the connecting members 233 (i.e., portions other than the outer peripheral edge portions) form light transmitting parts 25 that are capable of transmitting the laser beam emitted from the light source part 7 therethrough. In the example shown in FIG. 2, the LFL device 2 includes the light transmitting parts 25 on the (−Y)-side outer surface and on the (+Y)-side outer surface.

Between the two light transmitting members 232, two side-wall members 234 are arranged spaced from each other in the X direction. Each of the two side-wall members 234 is a member having light transmission properties and having an approximately rectangular shape when viewed from the front. For example, the side-wall members 234 may be approximately flat plate-like transparent members and expand approximately perpendicularly to the Y direction. Each side-wall member 234 is fixedly mounted by being sandwiched from the (+Y) and (−Y) sides by the two light transmitting members 232.

Between the two side-wall members 234 in the X direction, there is a gap that is long in the Z direction and that has an approximately rectangular gap when viewed from the front, and the gap forms a light-transmitting flow path 241 by being sandwiched from the (+Y) and (−Y) sides by the two light transmitting members 232, the light-transmitting flow path 241 extending in approximately parallel with the Z direction. The light-transmitting flow path 241 has an approximately rectangular section perpendicular to the Z direction and has approximately the same shape along approximately the entire length of the light-transmitting flow path 241. The circumstance (i.e., (+X), (+Y), (−X), and (−Y) sides) of the light-transmitting flow path 241 provided inside the device body 21 is surrounded by the side-wall members 234 and the light transmitting members 232 having light transmission properties. A portion of the light-transmitting flow path 241 that is included in the aforementioned scanned region 70 (i.e., a portion overlapping the scanned region 70 when viewed from the front) serves as a light receiver 240 that is irradiated with the laser beam emitted from the light source part 7 and transmitted through the light transmitting part 25. In the example shown in FIG. 1, the area of the light-transmitting flow path 241 other than upper and lower end portions thereof serves as the light receiver 240.

As described above, the laser beam reflected by the galvano scanner 72 is guided to the light transmitting part 25 of the LFL device 2 and enters the LFL device 2 in approximately parallel with the Y direction (i.e., approximately perpendicularly to the (−Y)-side outer surface of the light transmitting member 232 on the (−Y) side). That is, the direction of incidence of the laser beam on the light receiver 240 is approximately parallel to the thickness direction of the device body 21. In the example shown in FIG. 1, the light receiver 240 extends in approximately parallel with the Z direction (i.e., the up-down direction).

The lower end of the light-transmitting flow path 241 (i.e., the (−Z)-side end) is connected to a first flow path 242 provided in the lower portion of the frame 231. The first flow path 242 is a flow path that penetrates the interior of the frame 231 in the lower portion of the frame 231. The first flow path 242 extends in the (−Z) direction from the lower end of the light-transmitting flow path 241, bends to the (+X) side at a bend 243, and extends in approximately parallel with the (+X) direction. The (+X)-side end of the first flow path 242 is connected to the supply line 32 of the dispersion supplier 3 via a supply port 261 provided on the side face on the (+X) side of the device body 21.

The upper end of the light-transmitting flow path 241 (i.e., the (+Z)-side end) is connected to a second flow path 244 provided in the upper portion of the frame 231. The second flow path 244 is a flow path that penetrates the interior of the frame 231 in the upper portion of the frame 231. The second flow path 244 extends in the (+Z) direction from the upper end of the light-transmitting flow path 241, bends to the (−X) side at a bend 245, and extends in approximately parallel with the (−X) direction. The (−X)-side end of the second flow path 244 is connected to the collection line 42 of the dispersion collector 4 via a drain port 262 provided on the side face on the (−X) side of the device body 21.

In the following description, the first flow path 242, the light-transmitting flow path 241, and the second flow path 244, which are provided inside the LFL device 2, may also be collectively referred to as the “internal flow path 24.” In the LFL apparatus 1, the metal particle dispersion 91 supplied from the dispersion supplier 3 via the supply port 261 to the inside of the LFL device 2 (i.e., the internal flow path 24) flows through the first flow path 242 of the internal flow path 24, reaches the lower end of the light-transmitting flow path 241, and flows upward from the lower end of the light-transmitting flow path 241. The metal particle dispersion 91 then flows from the upper end of the light-transmitting flow path 241 into the second flow path 244, flows through the second flow path 244, and is drained via the drain port 26 to the outside of the LFL device 2 via the drain port 26 (i.e., from the internal flow path 242). The metal particle dispersion 91 drained from the internal flow path 24 is collected by the dispersion collector 4. The aforementioned supply port 261 is located at the upstream end of the internal flow path 24 in the device body 21, and the drain port 262 is located at the downstream end of the internal flow path 24.

The ultrasound applier 22 is mounted on the device body 21 in the vicinity of the internal flow path 24. In the example shown in FIG. 1, the ultrasound applier 22 is mounted on the central portion in the X direction at the lower end of the device body 21. The ultrasound applier 22 includes an ultrasonic vibrator 221 and a horn 222. The ultrasonic vibrator 221 converts high-frequency power into ultrasound. For example, the ultrasonic vibrator 221 may be an approximately circular columnar or disk-like member. The horn 222 is fixedly mounted on the upper surface of the ultrasonic vibrator 221 and is disposed below and in the vicinity of the bend 243 of the first flow path 242 of the internal flow path 24. For example, the horn 222 may be formed of metal such as stainless steel.

The horn 222 includes an approximately disk-like horn bottom and an approximately columnar horn top that protrudes upward from the central portion of the upper surface of the horn bottom. The upper end of the horn top is arranged in closer proximity to the bend 243 of the first flow path 242. The horn 222 transmits the ultrasound generated by the ultrasonic vibrator 221 to the internal flow path 24 and applies the ultrasound to the metal particle dispersion 91 that is flowing through the internal flow path 24. In the example shown in FIG. 1, the application of ultrasound to the metal particle dispersion 91 is conducted in the first flow path 242 located between the supply port 261 and the light-transmitting flow path 241. In other words, the application of ultrasound to the metal particle dispersion 91 is conducted between the supply port 261 and the light receiver 240 of the internal flow path 24. The ultrasound applied to the metal particle dispersion 91 by the ultrasound applier 22 may have frequencies of, for example, 20 Hz to 1000 kHz.

The LFL apparatus 1 improves dispersibility of metal microparticles in the metal particle dispersion 91 by applying ultrasound to the metal particle dispersion 91. In other words, the application of ultrasound allows metal microparticles to be dispersed approximately uniformly in the metal particle dispersion 91. In yet other words, the application of ultrasound suppresses variations in the density of metal microparticles dispersed in the metal particle dispersion 91 depending on position.

In the LFL apparatus 1, the metal particle dispersion 91 to which ultrasound has been applied by the ultrasound applier 22 (i.e., the metal particle dispersion 91 containing metal microparticles with improved dispersibility) flows through the light-transmitting flow path 241 from the lower side to the upper side and is irradiated at the light receiver 240 with the aforementioned laser beam transmitted through the light transmitting part 25. Accordingly, the laser beam is approximately uniformly applied to a large number of metal microparticles dispersed in the metal particle dispersion 91, so that these metal microparticles are approximately uniformly fragmented into smaller particles. As a result, the metal particle dispersion 91 transmitted through the LFL device 2 and collected by the dispersion collector 4 exhibits improved uniformity in the particle diameter of fragmented metal microparticles contained therein.

The metal microparticles in the metal particle dispersion 91 collected by the dispersion collector 4 (i.e., metal microparticles after fragmentation) may have an average particle diameter of, for example, less than or equal to 10 nm and preferably less than or equal to 5 nm. There are no particular limitations on the lower limit for the average particle diameter, but for example, the average particulate diameter may be greater than or equal to 2 nm. The average particle diameter is obtained by a method similar to the aforementioned method of obtaining the average particle diameter of metal microparticles in the metal particle dispersion 91 contained in the dispersion supplier 3 (i.e., metal microparticles before fragmentation).

As described thus far, the LFL device 2 includes the device body 21 and the ultrasound applier 22. The ultrasound applier 22 is mounted on the device body 21. The device body 21 includes the internal flow path 24 that allows passage of the metal particle dispersion 91 in which metal microparticles are dispersed. The ultrasound applier 22 applies ultrasound to the metal particle dispersion 91 that is flowing through the internal flow path 24. The outer surface of the device body 21 is provided with the light transmitting part 25 that transmits a laser beam. The laser beam is irradiated to the metal particle dispersion 91 in the internal flow path 24 to which ultrasound has been applied by the ultrasound applier 22.

As described above, since the LFL device 2 improves dispersibility of metal microparticles in the metal particle dispersion 91 by the application of ultrasound, it is possible to improve uniformity of irradiation of the metal microparticles with laser beams. As a result, it is possible to improve uniformity in the particle diameter of fragmented metal microparticles by irradiation with laser beams.

As described above, the device body 21 includes the supply port 261 located at the upstream end of the internal flow path 24 and the drain port 262 located at the downstream end of the internal flow path 24. In the device body 21, the metal particle dispersion 91 is supplied via the supply port 261. The metal particle dispersion 91 irradiated with the laser beam transmitted through the light transmitting part 25 is drained from the device body 21 via the drain port 262. The internal flow path 24 includes the light receiver 240 that is irradiated with the laser beam transmitted through the light transmitting part 25. It is preferable that the application of ultrasound to the metal particle dispersion 91 by the ultrasound applier 22 is conducted between the supply port 261 and the light receiver 240 of the internal flow path 24.

This allows the metal particle dispersion 91 to be supplied to the light receiver 240 immediately after the dispersibility of metal microparticles is improved by the application of ultrasound. Thus, the light receiver 240 favorably improves uniformity of irradiation of metal microparticles with laser beams. As a result, it is possible to further improve uniformity in the particle diameter of metal microparticles after fragmentation.

As described above, the internal flow path 24 includes the light receiver 240 that is irradiated with the laser beam transmitted through the light transmitting part 25. It is preferable that the light receiver 240 extends in the up-down direction and the metal particle dispersion 91 flows from the lower side to the upper side in the light receiver 240. This allows the metal particle dispersion 91 to fill the flow path without any clearance in the light receiver 240 (i.e., allows the light receiver 240 to be filled with the metal particle dispersion 91) even if the flow rate of the metal particle dispersion 91 is relatively low. As a result, it is possible to efficiently and favorably irradiate the metal particle dispersion 91 with the laser beam. This results in efficient fragmentation of metal microparticles.

As described above, the internal flow path 24 includes the light receiver 240 that is irradiated with the laser beam transmitted through the light transmitting part 25. The direction of incidence of the laser beam on the light receiver 240 is parallel to the thickness direction of the device body 21. Preferably, the thickness of the device body 21 may be smaller than the dimensions of the device body 21 in the longitudinal and lateral directions perpendicular to the thickness direction. Accordingly, it is possible to increase the length of the light receiver 240 that receives the laser beam while achieving favorable transmission of the laser beam in the light receiver 240. This results in improved efficiency of irradiation of the metal particle dispersion 91 with laser beams and accordingly improves the efficiency of fragmentation of metal microparticles.

As described above, the LFL apparatus 1 includes the above-described LFL device 2, the dispersion supplier 3, the light source part 7, and the dispersion collector 4. The dispersion supplier 3 supplies the metal particle dispersion 91 to the internal flow path 24 of the LFL device 2. The light source part 7 emits a laser beam toward the light transmitting part 25 of the LFL device 2. The dispersion collector 4 collects the metal particle dispersion 91 drained from the internal flow path 24 of the LFL device 2. Accordingly, it is possible to obtain fragmented metal microparticles with improved uniformity in particle diameter.

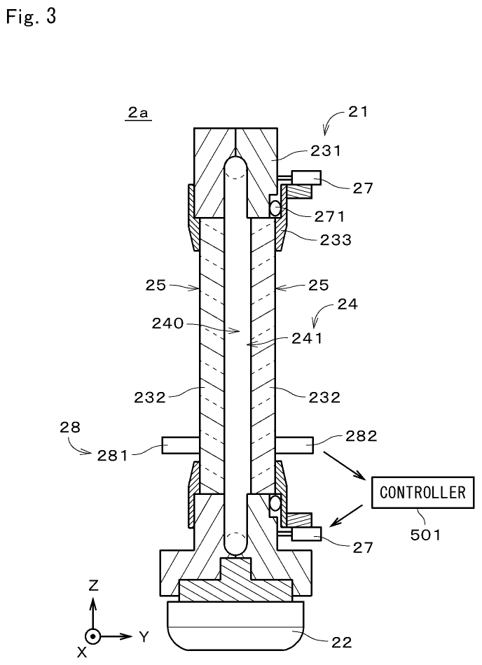

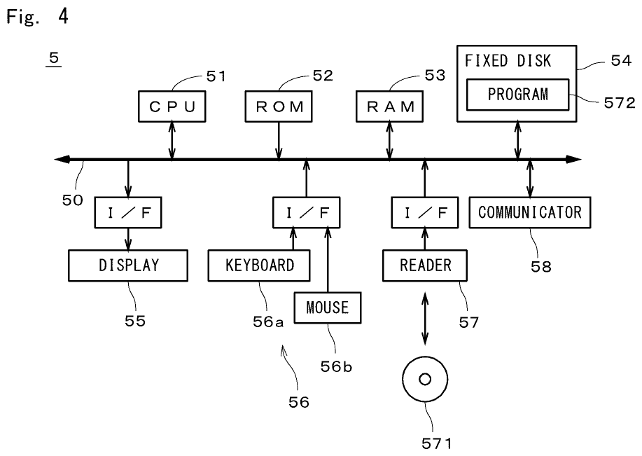

Next, an LFL device 2a according to Embodiment 2 of the present invention will be described with reference to FIGS. 3 and 4. For example, instead of the above-described LFL device 2, the LFL device 2a may be provided in the LFL apparatus 1 shown in FIGS. 1 and 2 and used in fragmentation of metal microparticles in the metal particle dispersion 91 by using the LFL method. FIG. 3 is a diagram showing a longitudinal section in the center of the LFL device 2a in the X direction in enlarged dimensions. FIG. 4 is a diagram showing a configuration of a computer 5 that realizes a controller 501 (described later) of the LFL device 2a.

As shown in FIG. 3, the LFL device 2a further includes a flow-path-thickness changer 27, a light-transmission-rate measurement device 28, and the controller 501 in addition to each constituent element of the LFL device 2 shown in FIGS. 1 and 2. The other configuration of the LFL device 2a is approximately the same as the configuration of the LFL device 2. In the following description, among the constituent elements of the LFL device 2a, those that correspond to constituent elements of the LFL device 2 are given the same reference signs as the constituent elements of the LFL device 2.

In the LFL device 2a, the light transmitting member 232 on the (+Y) side, out of the two light transmitting members 232, is mounted on the frame 231 so as to be movable in the Y direction (i.e., the thickness direction) together with the connecting member 233 on the (+Y) side. Specifically, the connecting member 233 on the (+Y) side, which is fixed to the light transmitting member 232 on the (+Y) side, is connected indirectly to the frame 231 via the flow-path-thickness changer 27. In the example shown in FIG. 3, an elastically deformable sealing member 271 (e.g., an O-ring) is provided between the connecting member 233 and the frame 231.

In the LFL device 2a, when the connecting member 233 on the (+Y) side is moved in the Y direction by the flow-path-thickness changer 27, the light transmitting member 232 on the (+Y) side is also moved in the Y direction, and the distance between the two light transmitting members 232 is changed. As a result, the thickness of the light-transmitting flow path 241 in the thickness direction is changed, and the thickness of the light receiver 240, which is part of the light-transmitting flow path 241, in the thickness direction is also changed. For example, the flow-path-thickness changer 27 may be configured by a plurality of air cylinders or linear motors. Note that the structure, type, and any other feature of the flow-path-thickness changer 27 may be modified in various ways. The LFL device 2a may also be configured such that, instead of or in addition to the light transmitting member 232 on the (+Y) side, the light transmitting member 232 on the (−Y) side is movable by the flow-path-thickness changer 27.

The light-transmission-rate measurement device 28 is an optical measurement device that measures the light transmitting rate of the metal particle dispersion 91 (see FIG. 1) in the light receiver 240 of the internal flow path 24. The light-transmission-rate measurement device 28 includes a projector unit 281 and a light receiving unit 282. The projector unit 281 is provided at a position overlapping the light receiver 240 in the Y direction on the (−Y)-side main surface of the light transmitting member 232 in FIG. 3. For example, the projector unit 281 may include a light source that emits light in the (+Y) direction. The wavelengths of the light emitted from the projector unit 281 may be changed, and in the example shown in FIG. 3, the light emitted from the projector unit 281 has approximately the same wavelength as the above-described laser beam emitted from the light source part 7.

The light receiving unit 282 is mounted at a position overlapping the light receiver 240 in the Y direction on the (+Y)-side main surface of the light transmitting member 232 in FIG. 3. The light receiving unit 282 includes a light-receiving sensor that receives light emitted from the projector unit 281 and transmitted through the light receiver 240. The light receiving unit 282 obtains the transmission rate of light (light transmission rate) between the projector unit 281 and the light receiving unit 282 from the output of the light-receiving sensor.

In the case where the two light transmitting members 232 have relatively high light transmission rates, the light transmission rate obtained by the light receiving unit 282 is regarded as the light transmission rate of the metal particle dispersion 91 flowing through the light receiver 240. On the other hand, in the case where the two light transmitting members 232 have relatively low light transmission rates, the light transmission rate of the metal particle dispersion 91 flowing through the light receiver 240 is obtained in consideration of the light transmission rate of each light transmitting member 232 and on the basis of the light transmission rate obtained by the light receiving unit 282. The light transmission rate of the metal particle dispersion 91 in the light receiver 240, acquired by the light-transmission-rate measurement device 28, is output to the computer 5 shown in FIG. 4.

The computer 5 is configured as a common computer system that includes a CPU 51, ROM 52, RAM 53, a fixed disk 54, a display 55, an input device 56, a reader 57, a communicator 58, and a bus 50. The CPU 51 performs various types of arithmetic processing. The ROM 52 stores basic programs. The RAM 53 stores a variety of information. The fixed disk 54 stores information. The display 55 serves as a display device that displays a variety of information such as images.

The input device 56 includes a keyboard 56a and a mouse 56b that accept input from an operator. The reader 57 reads out information from a computer-readable recording medium 571 such as an optical disk, a magnetic disk, a magneto-optical disk, or a memory card. The display 55, the keyboard 56a, the mouse 56b, and the reader 57 are connected to the bus 50 via interfaces I/F. The communicator 58 transmits and receives signals to and from external devices or the like arranged outside the computer 5. The bus 50 is a signal circuit that connects the CPU 51, the ROM 52, the RAM 53, the fixed disk 54, the display 55, the input device 56, the reader 57, and the communicator 58.

In the computer 5, a program 572 is read out from the recording medium 571 via the reader 57 and stored in the fixed disk 54 in advance. The program 572 may be stored in the fixed disk 54 via a network. The CPU 51 executes arithmetic processing while using the RAM 53 or the fixed disk 54 in accordance with the program 572. The CPU 51 functions as an operation part in the computer 5. Besides the CPU 51, any other configuration that functions as an operation part may be employed.

The computer 5 realizes the controller 501 shown in FIG. 3 by the CPU 51, the ROM 52, the RAM 53, the fixed disk 54, and peripheral configurations of these constituent elements. The controller 501 drives the flow-path-thickness changer 27 in accordance with the output of the light-transmission-rate measurement device 28 (i.e., the light transmission rate of the metal particle dispersion 91 in the light receiver 240) and adjusts the thickness of the light receiver 240 in the Y direction (i.e., the thickness direction) such that metal microparticles in the metal particle dispersion 91 flowing through the light receiver 240 are irradiated with the laser beam of sufficient intensity.

Specifically, in the case where the metal particle dispersion 91 in the light receiver 240 has a relatively low light transmission rate (e.g., the concentration of metal microparticles in the metal particle dispersion 91 is relatively high), the flow-path-thickness changer 27 moves the light transmitting member 232 on the (+Y) side in the (−Y) direction so as to reduce the thickness of the light receiver 240 in the Y direction. This allows even metal microparticles located away from the light source part 7 (i.e., located in a (+Y)-side region of the light receiver 240) to be irradiated with the laser beam of sufficient intensity in the light receiver 240 and accordingly achieves favorable fragmentation of the metal microparticles.

On the other hand, in the case where the metal particle dispersion 91 in the light receiver 240 has a relatively high light transmission rate (e.g., the concentration of metal microparticles in the metal particle dispersion 91 is relatively low), the flow-path-thickness changer 27 moves the light transmitting member 232 on the (+Y) side in the (+Y) direction so as to increase the thickness of the light receiver 240 in the Y direction. This increase the flow rate of the metal particle dispersion 91 flowing through the light receiver 240 while allowing even metal microparticles located away from the light source part 7 to be irradiated with the laser beam of sufficient intensity in the light receiver 240. As a result, it is possible to increase the amount of the metal particle dispersion 91 subjected to laser fragmentation in a liquid per unit time. Note that the light transmission rate of the metal particle dispersion 91 in the light receiver 240 may also vary according to, for example, the type of metal microparticles or the solvent, besides the concentration of metal microparticles in the metal particle dispersion 91.

As described above, in the LFL device 2a, the internal flow path 24 includes the light receiver 240 that is irradiated with the laser beam transmitted through the light transmitting part 25. The direction of incidence of the laser beam on the light receiver 240 is parallel to the thickness direction of the device body 21. The LFL device 2a further includes the flow-path-thickness changer 27 that changes the thickness of the light receiver 240 in the thickness direction. Accordingly, the light receiver 240 with an appropriate thickness that is suited to, for example, the concentration of the metal particle dispersion 91 or the type of metal microparticles (i.e., a thickness that is not excessively thin and that is favorable for the transmission of the laser beam) can be used in the laser fragmentation of metal microparticles in a liquid.

As described above, it is preferable that the LFL device 2a may further include the light-transmission-rate measurement device 28 and the controller 501, the light-transmission-rate measurement device 28 measuring the light transmission rate of the metal particle dispersion 91 in the light receiver 240, the controller 501 driving the flow-path-thickness changer 27 in accordance with the output of the light-transmission-rate measurement device 28. This allows the thickness of the light receiver 240 to be automatically adjusted to an appropriate thickness according to the light transmission rate of the metal particle dispersion 91.

The LFL apparatus 1 and the LFL devices 2 and 2a described above may be modified in various ways.

For example, in the LFL device 2, the metal particle dispersion 91 may not necessarily flow from the lower side to the upper side in the light receiver 240, and the direction of the flow may be changed in various ways. For example, the light receiver 240 may bend or curve in the horizontal direction or any other direction, or may meander. The same applies to the LFL device 2a.

In the LFL device 2, the application of ultrasound to the metal particle dispersion 91 by the ultrasound applier 22 is not necessarily conducted between the light receiver 240 and the supply port 261, and may be conducted at any other position. For example, the application of ultrasound may be conducted at the upstream end of the light receiver 240 (in the example shown in FIG. 1, the lower end of the light receiver 240). Alternatively, the application of ultrasound to the metal particle dispersion 91 flowing through the internal flow path 24 may be conducted at any of various positions located upstream of the light receiver 240 (e.g., at the supply port 261). The same applies to the LFL device 2a.

In the LFL device 2a, the projector unit 281 and the light receiving unit 282 of the light-transmission-rate measurement device 28 are not necessarily arranged facing each other with the light receiver 240 sandwiched therebetween, and for example in the case where the supply line 32 is a transparent line, they may be arranged facing each other with the supply line 32 sandwiched therebetween. In this case, the light transmission rate of the light receiver 240 is obtained based on, for example, the output of the light receiving sensor of the light receiving unit 282, the light transmission rate of the supply line 32, and the relationship between the diameter of the supply line 32 and the thickness of the light receiver 240. In the case where the projector unit 281 and the light receiving unit 282 are arranged with the supply line 32 sandwiched therebetween, it is preferable that the projector unit 281 and the light receiving unit 282 are arranged between the solution sender 33 and the supply port 261.

The structure, type, and any other feature of the light-transmission-rate measurement device 28 are not limited to the examples described above, and may be modified in various ways. For example, in the LFL device 2a, the computer 5 may realize the operation part that obtains the light transmission rate of the metal particle dispersion 91 from the output of the light receiving sensor of the light receiving unit 282.

In the LFL device 2a, the flow-path-thickness changer 27 is not necessarily driven by the controller 501, and the thickness of the light receiver 240 may be changed by the operator of the LFL apparatus 1 manually operating the flow-path-thickness changer 27.

The LFL devices 2 and 2a may be provided in an LFL apparatus that has a different configuration from the above-described LFL apparatus 1 and that is used in laser fragmentation of metal microparticles in a liquid.

The configurations of the above-described embodiment and variations may be appropriately combined as long as there are no mutual inconsistencies.

While the invention has been shown and described in detail, the foregoing description is in all aspects illustrative and not restrictive. It is therefore to be understood that numerous modifications and variations can be devised without departing from the scope of the invention.

### REFERENCE SIGNS LIST

1 LFL apparatus (laser-fragmentation-in liquid apparatus)
2, 2a LFL device (laser-fragmentation-in-liquid device)
3 dispersion supplier
4 dispersion collector
7 light source
21 device body
22 ultrasound applier
24 internal flow path
25 light transmitting part
27 flow-path-thickness changer
28 light-transmission-rate measurement device
91 metal particle dispersion
240 light receiver
261 supply port
262 drain port
501 controller

1. A laser-fragmentation-in-liquid device comprising:
a device body; and
an ultrasound applier mounted on said device body,
wherein said device body includes an internal flow path that allows passage of metal particle dispersion in which metal microparticles are dispersed,
said ultrasound applier applies ultrasound to said metal particle dispersion that is flowing through said internal flow path, and
an outer surface of said device body is provided with a light transmitting part that transmits a laser beam, said laser beam being irradiated to said metal particle dispersion in said internal flow path to which ultrasound has been applied by said ultrasound applier.

2. The laser-fragmentation-in-liquid device according to claim 1, wherein
said device body includes:
a supply port that is located at an upstream end of said internal flow path and to which said metal particle dispersion is supplied; and
a drain port that is located at a downstream end of said internal flow path and from which said metal particle dispersion irradiated with said laser beam transmitted through said light transmitting part is drained,
said internal flow path includes a light receiver that is irradiated with said laser beam transmitted through said light transmitting part, and
the application of ultrasound to said metal particle dispersion by said ultrasound applier is conducted between said supply port and said light receiver of said internal flow path.

3. The laser-fragmentation-in-liquid device according to claim 1, wherein
said internal flow path includes a light receiver that is irradiated with said laser beam transmitted through said light transmitting part,
said light receiver extends in an up-down direction, and
said metal particle dispersion flows from a lower side to an upper side in said light receiver.

4. The laser-fragmentation-in-liquid device according to claim 1, wherein
said internal flow path includes a light receiver that is irradiated with said laser beam transmitted through said light transmitting part,
a direction of incidence of said laser beam on said light receiver is parallel to a thickness direction of said device body, and
said device body has a thickness smaller than dimensions of said device body in longitudinal and lateral directions perpendicular to said thickness direction.

5. The laser-fragmentation-in-liquid device according to claim 1, wherein
said internal flow path includes a light receiver that is irradiated with said laser beam transmitted through said light transmitting part, and
a direction of incidence of said laser beam on said light receiver is parallel to a thickness direction of said device body,
the laser-fragmentation-in-liquid device further comprising:
a flow-path-thickness changer that changes a thickness of said light receiver in said thickness direction.

6. The laser-fragmentation-in-liquid device according to claim 5, further comprising:
a light-transmission-rate measurement device that measures a light transmission rate of said metal particle dispersion in said light receiver; and
a controller that drives said flow-path-thickness changer in accordance with an output of said light-transmission-rate measurement device.

7. A laser-fragmentation-in-liquid apparatus comprising:
the laser-fragmentation-in-liquid device according to claim 1;
a dispersion supplier that supplies said metal particle dispersion to said internal flow path of said laser-fragmentation-in-liquid device;
a light source that emits a laser beam toward said light transmitting part of said laser-fragmentation-in-liquid device; and
a dispersion collector that collects said metal particle dispersion drained from said internal flow path of said laser-fragmentation-in-liquid device.
